(19) United States
(12) Patent Application Publication
(10) Pub. No.: US 2011/0075565 A1
(43) Pub. Date: Mar. 31, 2011

(54) SYSTEM AND METHOD FOR CONTROL NETWORK DEVICE

(75) Inventors: Seung-Hyun YOON, Daejeon-si (KR); Hyung-Seok Chung, Daejeon-si (KR); Sun-Me Kim, Daejeon-si (KR); Ho-Young Song, Daejeon-si (KR); You-Hyeon Jeong, Daejeon-si (KR)

(73) Assignee: Electronics and Telecommunications Research Institute, Daejeon (KR)

(21) Appl. No.: 12/878,376

(22) Filed: Sep. 9, 2010

(30) Foreign Application Priority Data
Sep. 25, 2009 (KR) 10-2009-0091062
Dec. 18, 2009 (KR) 10-2009-0127297

(51) Int. Cl. H04L 1/00

(52) U.S. Cl. 370/237

(57) ABSTRACT

A control system and method for reducing the amount of power consumption of a communication network is provided. The amount of traffic usage and power consumption of communication equipment in the communication network is collected and energy efficiency of the communication equipment is calculated. An operation of the communication equipment and a communication path or routing of the communication network are controlled according to the calculated energy efficiency. Therefore, an operation of unnecessary communication equipment is controlled, thereby reducing the power consumption of the communication network.

### CROSS-REFERENCE TO RELATED APPLICATION(S)

This application claims the benefit under 35 U.S.C. §119(a) of Korean Patent Application Nos. 10-2009-0091062, filed on Sep. 25, 2009, and 10-2009-0127297, filed on Dec. 18, 2009, the entire disclosures of which are incorporated herein by references for all purposes.

### BACKGROUND

1. Field

The following description relates to a control system and method for reducing power consumption in a communication network, and more particularly, to a communication network control system and method for controlling an operation of a network device, a communication path of a communication network, or routing by collecting the amount of traffic used by the network device and power consumption in a communication network and calculating energy efficiency of the network device.

2. Description of the Related Art

Generally, a communication network is designed, constructed, and maintained in terms of capacity based on peak time in order to assure a certain level of performance at the peak time. In addition, several network devices, ports, and lines are typically installed and managed in duplicate to secure a necessary capacity when a communication network is designed and constructed since the capacity that a single network device or a single line can provide is limited.

The communication network has been designed and built to accommodate the maximum communication demands, and once the communication network starts operating, it is operated for 24 hours regardless of the amount of traffic.

Hence, except for the peak time which is only a particular period of time in a day, the network devices are unnecessarily operated, resulting in the waste of power consumption and degradation of energy efficiency of the communication network.

### SUMMARY

In one general aspect, provided is a communication network control system which controls an operation of one or more pieces of communication equipment, which consists of a communication network, based on energy efficiency of the communication equipment, the communication network control system including: an energy efficiency monitoring unit configured to collect the amount of traffic usage and power consumption in the communication network and calculate the energy efficiency of the communication equipment; an equipment control unit configured to control the operation of the communication equipment in the communication network according to the calculated energy efficiency; and a communication network control unit configured to adjust a communication path or routing of the communication network corresponding to the control of the operation of the communication equipment.

When the communication equipment is of a chassis type, the equipment control unit may control the operation of the communication equipment on a line card-by-line card basis, and when the communication equipment is of a pizza-box type, the equipment control unit may control the operation of the communication equipment on an equipment-by-equipment basis.

When a line and power control of the communication equipment can be performed on a port-by-port basis, the equipment control unit may control the operation of the communication equipment on a port-by-port basis.

In another general aspect, provided is a method of controlling an operation of one or more pieces of communication equipment, which consists of a communication network, based on energy efficiency of the communication equipment, the method including: collecting the amount of traffic usage and power consumption of the communication equipment in the communication network and calculating the energy efficiency of the communication equipment; determining whether network operating management of the communication equipment is appropriate or not based on the energy efficiency; determining whether to operate each of the communication equipment based on the energy efficiency when it is determined that topology reduction is required; adjusting a communication path or routing of the communication network according to the determination result of whether to operate each of the communication equipment; and controlling an operation of corresponding communication equipment according to the determination result of whether to operate the communication equipment.

In yet another general aspect, provided is a method of controlling an operation of one or more pieces of communication equipment, which consists of a communication network, based on energy efficiency of the communication equipment, the method including: calculating the energy efficiency using history data of previously collected amounts of traffic usage and power consumption; setting a time schedule for controlling whether to operate each of the communication equipment based on the calculated energy efficiency; and controlling an operation of corresponding communication equipment and adjusting a communication path or routing of the communication network according to the set time schedule.

In still another general aspect, provided is a method of controlling an operation of one or more pieces of communication equipment, which consists of a communication network, based on energy efficiency of the communication equipment, the method including: setting a threshold value with respect to a specific measurement value for determining expansion, reduction, and maintenance of a topology of the communication network, wherein the specific measurement value is obtained while controlling the operation of the communication equipment; when it is notified from the communication equipment that the specific measurement value reaches the threshold value, determining one of the expansion, reduction, and maintenance of the topology of the communication network according to the notified threshold value; and controlling the operation of the communication equipment and adjusting a communication path or routing of the communication network according to the determination result.

Other features and aspects will be apparent from the following detailed description, the drawings, and the claims.

### BRIEF DESCRIPTION OF THE DRAWINGS

FIG. 1 is a diagram illustrating an example of a communication network control system.

FIG. 2 is a diagram illustrating an example of pieces of communication equipment of different forms, which are controlled by a communication network control system.

FIG. 3 is a flowchart illustrating an example of a method of operating a communication network control system.

FIG. 4 is a flowchart illustrating an example of a method of monitoring the energy efficiency shown in FIG. 3.

FIG. 5 is a flowchart illustrating another example of a method of operating a communication network control system.

FIG. 6 is a flowchart illustrating another example of a method of operating a communication network control system.

Throughout the drawings and the description, unless otherwise described, the same drawing reference numerals should be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

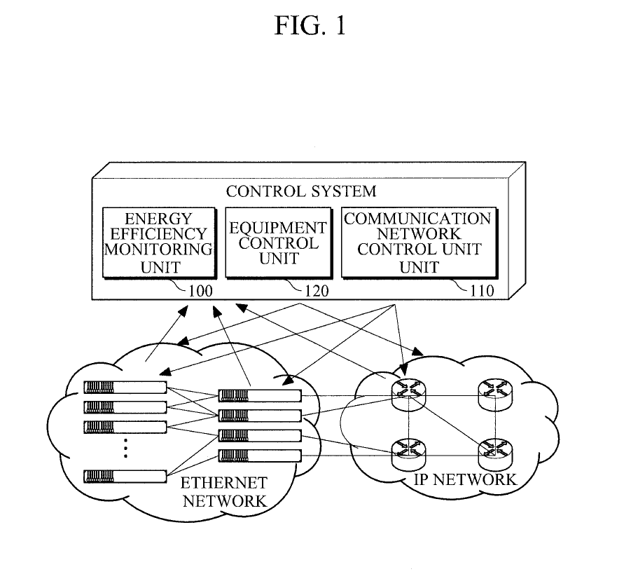

FIG. 1 illustrates an example of a communication network control system.

Referring to FIG. 1, the communication network control system may include an energy efficiency monitoring unit 100, an equipment control unit 110, and a communication network control unit 120.

The energy efficiency monitoring unit 100 collects the amount of power consumption and the amount of traffic usage of communication equipment in a communication network to calculate the energy efficiency of the communication equipment.

The equipment control unit 110 controls an operation of the communication equipment according to the calculated energy efficiency, and the communication control unit 120 adjusts a communication path or routing of the communication network corresponding to the control of the operation of the communication equipment.

FIG. 1 shows a simplified communication network consisting of an Ethernet network and an Internet protocol (IP) network. In such a communication network, the power consumption of the entire communication network can be reduced by controlling power usage of unnecessary devices or modules based on the amount of traffic usage, the amount of power consumption, and the energy efficiency.

In the event of low energy efficiency, that is, at a time when less traffic is used, redundant or unnecessary communication equipment may be switched to power-save mode/sleep mode to reduce power consumption. In this case, if some communication equipment is arbitrarily switched to power-save mode or sleep mode, communication may be disconnected temporarily or for a long time. Thus, to prevent such disconnection, a topology of the communication network is changed, that is, a path and routing is adjusted before performing the power control of the communication equipment, thereby controlling not to use the communication equipment which is to be switched to power-save/sleep mode.

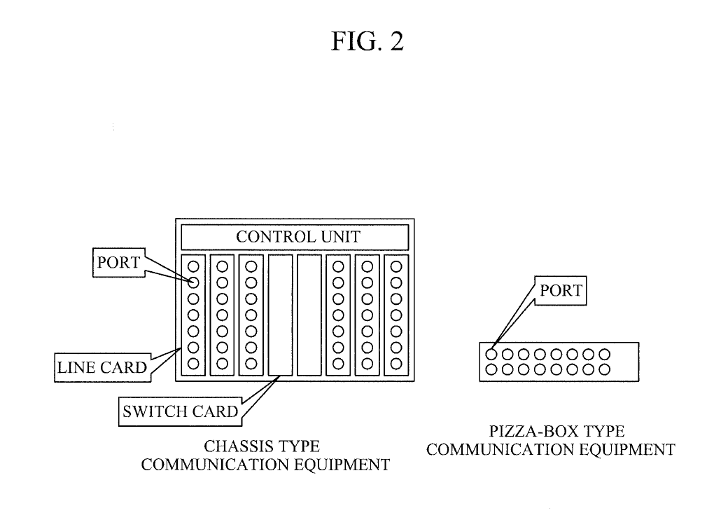

FIG. 2 illustrates an example of pieces of communication equipment of different forms, which are controlled by a communication network control system. As shown in FIG. 2, there are generally two forms of communication equipment. One is chassis-type communication equipment which has a large volume and is configured to be easily extended. The other is pizza box-type communication equipment. Generally, pieces of pizza box-type equipment are redundantly installed to operate, whereas the chassis-type equipment is rarely redundantly installed other than duplexing due to its volume.

For power control, the pizza box-type communication equipment may be switched to power-save/sleep/normal mode on an equipment-by-equipment basis, and the chassis-type communication equipment may be switched on a line card-by-line card basis.

If communication equipment for which power can be controlled on a port-by-port basis is provided, the communication network control system may be capable of adjusting a path and routing and controlling power in very fine units.

To control a router, a switching path, or routing, routing of an Ethernet network (layer 2) and routing of an IP network (layer 3) should be adjusted, and to freely reduce and/or expand a topology of an IP-based network in practice, paths and routings of the layers 2 and 3 may be simultaneously adjusted.

For example, Ethernet routing and IP routing may be simultaneously adjusted to converge traffic onto one port when the amount of traffic flowing into a router decreases.

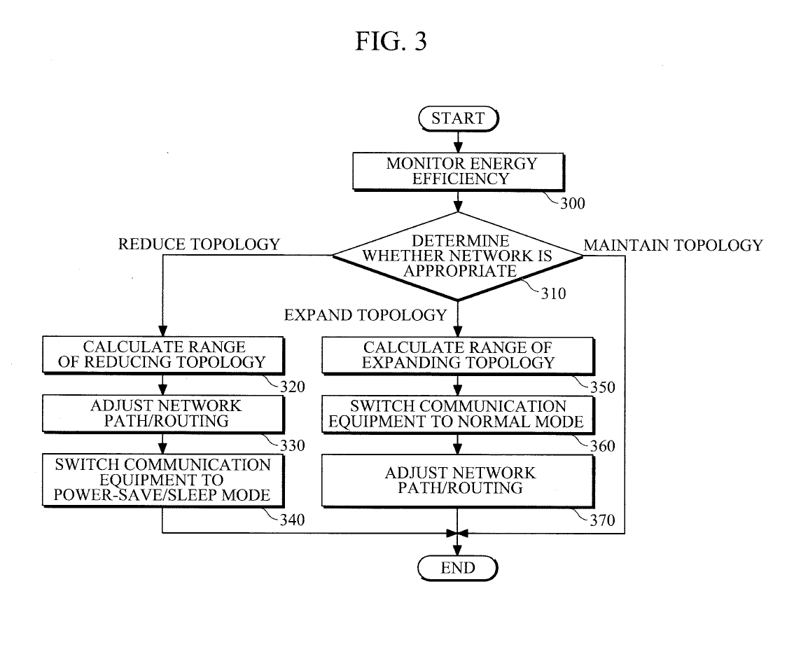

FIG. 3 illustrates a flowchart of an example of a method of operating a communication network control system.

First, the energy efficiency is monitored (300) by collecting the amount of traffic usage in a communication network and the amount of power consumption of communication equipment. Then, it is determined whether or not the network operating management is appropriate (310).

If the energy efficiency is low due to the decrease of traffic, an operating range of a node, a line card, and a port which are redundantly connected may be reduced by scaling down a topology (320). In addition, the network path and routing are controlled and changed (330) to prevent the communication from being disconnected, and the communication equipment is controlled to be switched to power-save or sleep mode on an equipment-by-equipment, a line card-by-line card, or a port-by-port basis (340).

In contrast, if the traffic increases more than a certain value, the topology is expanded (350), the communication equipment in power-save or sleep mode is switched to normal mode (360), and the network path and routing are controlled and adjusted to update the switched mode (370). If there is no need to control and adjust the network path and routing, the procedure is terminated.

The above procedures are periodically or repeatedly performed according to a set time schedule.

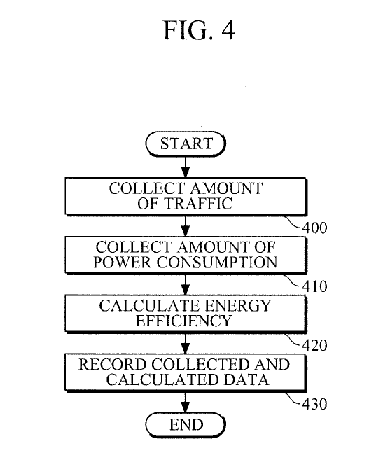

FIG. 4 illustrates a flowchart of an example of a method of monitoring the energy efficiency shown in FIG. 3.

The communication network control system collects the amount of traffic and the amount of power consumption (400 and 410), and calculates the energy efficiency based on the collected information (420). The energy efficiency may be calculated simply as a ratio between the amount of traffic and the amount of power consumption, or in many other ways.

The calculated energy efficiency is recorded in a database (430) to be used as a reference for determining whether the network operating management is appropriate or not.

The above procedures may be performed periodically according to a set time schedule, and the determination of whether the network operating management is appropriate may be performed with reference to history data as well as the calculated information.

Although a range of collecting the amount of traffic and the amount of power consumption is dependent on the presence of a relevant function in the communication equipment, the collecting should be performed at least on an equipment-by-equipment basis for the equipment-based control. In addition, for port-based control, the amount of traffic and the amount of power consumption should be collected on a port-by-port basis.

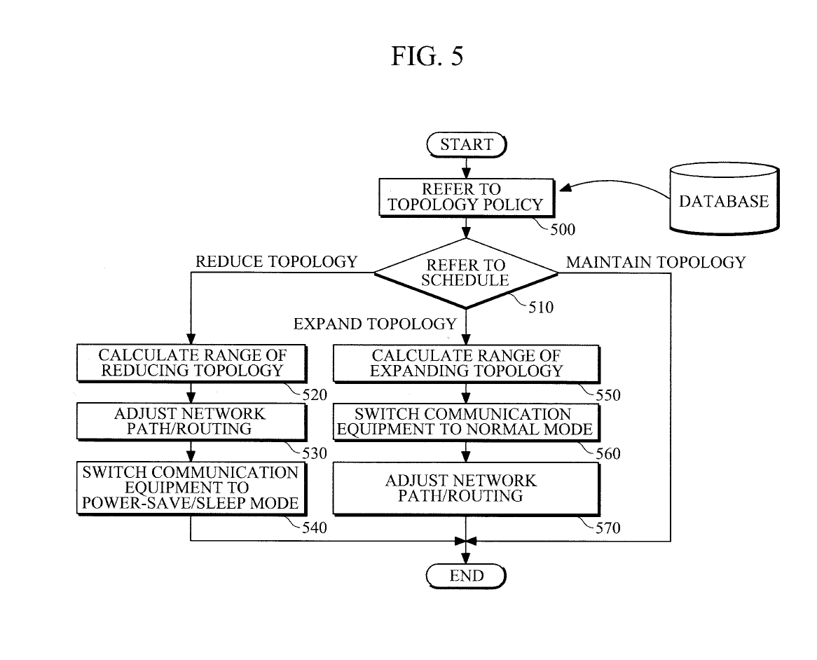

FIG. 5 illustrates a flowchart of another example of a method of operating a communication network control system.

If the energy efficiency is not updated online in real time and only history data is allowed to be used offline, expansion or reduction of the topology at each predetermined time period is previously determined based on data analysis and the determination result is stored in a database. Also, without performing operating including the monitoring of the energy efficiency (300) and the determination of whether the network operating management is appropriate (310) described with reference to FIG. 3, the procedures may be performed as described below. Here, information regarding the expansion or reduction of the topology may include information determining whether to operate each of specific communication equipment.

By use of the energy efficiency calculated using history data of the previously collected amount of traffic and amount of power consumption, a time schedule according to which operation of the communication network is controlled is set. The set time schedule is recorded and stored as a topology policy, and the procedures commence by referring to the time schedule (500).

According to the set time schedule (510), operation of corresponding communication equipment is controlled and the communication path and routing of the communication network are adjusted (520, 530, 540, 550, 560, and 570).

Once each of the communication equipment is determined to be operated, the subsequent procedures may be performed in the same manner as operations 320 to 370 shown in the example illustrated in FIG. 3.

The above procedures show an example of calculating a time of expanding and reducing the topology offline, recording the calculated time in a database, and controlling the communication equipment and network according to the calculation result. An operator or an external system may register a time of reducing or expanding a topology in a database or in a schedule, and the control system may calculate a range of expanding/reducing the topology and control the path and power consumption.

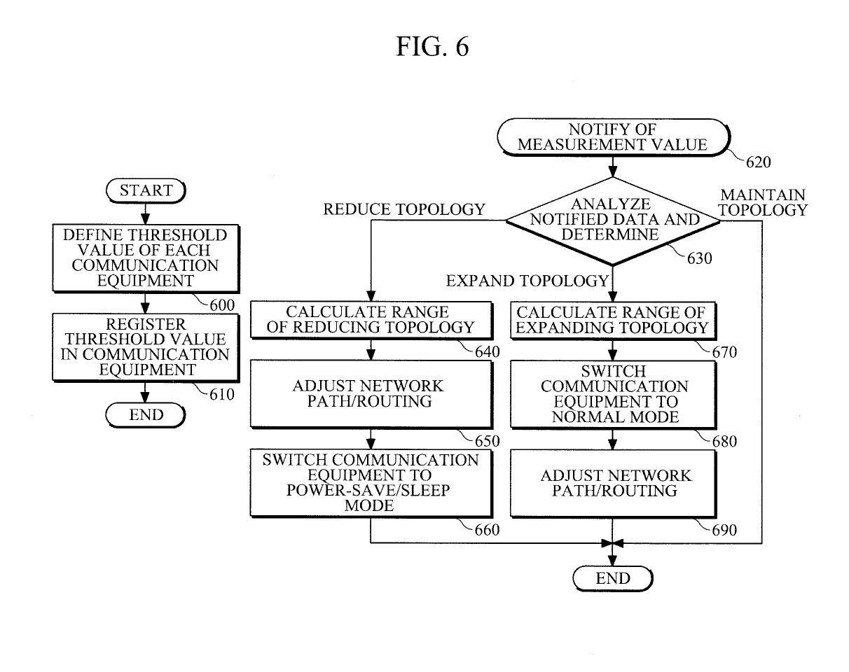

FIG. 6 illustrates a flowchart of another example of a method of operating a communication network control system.

If a threshold value with respect to a network change is registered in communication equipment and the control system can be correspondingly operated, the system control may be performed non-periodically, thereby increasing the control efficiency.

The control system or an operator defines the threshold value with respect to a measurement value critical for the communication equipment to determine the reduction or expansion of the topology (600) and registers the defined threshold value in the communication equipment (610).

The communication equipment notifies the control system of a measurement value (620). The control system determines whether the measurement value reaches the threshold value and correspondingly performs the reduction or expansion of the topology (630).

Here, the threshold value may be the amount of traffic, the amount of power consumption, or the energy efficiency value, a threshold value for reducing the topology and performing relevant operations (640, 650, and 660) and a threshold value for expanding the topology and performing relevant operations (670, 680, and 690) may be defined differently from one operation to another, or in a stepwise manner.

The functionality and operating procedures of the control system are not limited to being implemented in an additional external system, and may be implemented in communication equipment. Although, for convenience of explanation, the above operation methods are described as being performed by communication equipment such as a switch and a router that performs an exchange between an Ethernet network and an IP network, the methods are applicable to communication equipment or other communication network technologies that perform traffic transmission.

In addition, the state of the communication equipment, the line card, and the port may be represented as multiple-mode including standby mode, power-save mode, sleep mode, pause mode, and the like.

As described above, the power consumption of the communication network can be reduced by controlling operation state of unnecessary equipment.

A communication path or routing can be adjusted and power can be controlled in very fine units by providing communication equipment of which power can be controlled in a port-by-port basis.

Furthermore, the power consumption reduction can be realized in communication equipment or communication networks which perform traffic transmission, as well as in communication equipment such as a switch and a router that performs an exchange between an Ethernet network and an IP network.

The current embodiments can be implemented as computer readable codes in a computer readable record medium. Codes and code segments constituting the computer program can be easily inferred by a skilled computer programmer in the art. The computer readable record medium includes all types of record media in which computer readable data are stored. Examples of the computer readable record medium include a ROM, a RAM, a CD-ROM, a magnetic tape, a floppy disk, and an optical data storage. Further, the record medium may be implemented in the form of a carrier wave such as Internet transmission. In addition, the computer readable record medium may be distributed to computer systems over a network, in which computer readable codes may be stored and executed in a distributed manner.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A communication network control system which controls an operation of one or more pieces of communication equipment, which consists of a communication network, based on energy efficiency of the communication equipment, the communication network control system comprising:
an energy efficiency monitoring unit configured to collect the amount of traffic usage and power consumption in the communication network and calculate the energy efficiency of the communication equipment;
an equipment control unit configured to control the operation of the communication equipment in the communication network according to the calculated energy efficiency; and
a communication network control unit configured to adjust a communication path or routing of the communication network corresponding to the control of the operation of the communication equipment.

2. The communication network control system of claim 1, wherein when the communication equipment is of a chassis type, the equipment control unit controls the operation of the communication equipment on a line card-by-line card basis, and when the communication equipment is of a pizza-box type, the equipment control unit controls the operation of the communication equipment on an equipment-by-equipment basis.

3. The communication network control system of claim 1, wherein when a line and power control of the communication equipment can be performed on a port-by-port basis, the equipment control unit controls the operation of the communication equipment on a port-by-port basis.

4. A method of controlling an operation of one or more pieces of communication equipment, which consists of a communication network, based on energy efficiency of the communication equipment, the method comprising:
collecting the amount of traffic usage and power consumption of the communication equipment in the communication network and calculating the energy efficiency of the communication equipment;
determining whether network operating management of the communication equipment is appropriate or not based on the energy efficiency;
determining whether to operate each of the communication equipment based on the energy efficiency when it is determined that topology reduction is required;
adjusting a communication path or routing of the communication network according to the determination result of whether to operate each of the communication equipment; and
controlling an operation of corresponding communication equipment according to the determination result of whether to operate the communication equipment.

5. The method of claim 4, further comprising:
determining whether to operate each of the communication equipment based on the energy efficiency when it is determined that topology expansion is required;
controlling an operation of corresponding communication equipment based on the determination result of whether to operate each of the communication equipment; and
adjusting a communication path or routing of the communication network according to the determination result of whether to operate each of the communication equipment.

6. The method of claim 4, further comprising performing the procedures from the calculating of the energy efficiency of the communication equipment at predetermined time intervals again when it is determined that the operating management of the communication equipment is appropriate, or after the controlling of the operation of the corresponding communication equipment is performed.

7. A method of controlling an operation of one or more pieces of communication equipment, which consists of a communication network, based on energy efficiency of the communication equipment, the method comprising:
calculating the energy efficiency using history data of previously collected amounts of traffic usage and power consumption;
setting a time schedule for controlling whether to operate each of the communication equipment based on the calculated energy efficiency; and
controlling an operation of corresponding communication equipment and adjusting a communication path or routing of the communication network according to the set time schedule.

8. A method of controlling an operation of one or more pieces of communication equipment, which consists of a communication network, based on energy efficiency of the communication equipment, the method comprising:
setting a threshold value with respect to a specific measurement value for determining expansion, reduction, and maintenance of a topology of the communication network, wherein the specific measurement value is obtained while controlling the operation of the communication equipment;
when it is notified from the communication equipment that the specific measurement value reaches the threshold value, determining one of the expansion, reduction, and maintenance of the topology of the communication network according to the notified threshold value; and
controlling the operation of the communication equipment and adjusting a communication path or routing of the communication network according to the determination result.
